(19) United States
(12) Patent Application Publication
(10) Pub. No.: US 2011/0238367 A1
(43) Pub. Date: Sep. 29, 2011

(54) ROTATIONAL ANGLE DETECTING DEVICE

(75) Inventors: Koichiro MATSUMOTO, Kyoto-city (JP); Yoshiyuki KONO, Obu-city (JP)

(73) Assignee: DENSO CORPORATION, Kariya-city (JP)

(21) Appl. No.: 13/072,223

(22) Filed: Mar. 25, 2011

(30) Foreign Application Priority Data
Mar. 29, 2010 (JP) 2010-74423

(51) Int. Cl. G06F 19/00

(52) U.S. Cl. 702/151

(57) ABSTRACT

A rotational angle detecting device includes a magnetic member, a magnetic sensor and a processing unit. The magnetic sensor includes a sensor element disposed to rotate relative to the magnetic member in accordance with a rotation of a rotating object and outputting signals according to a change in a magnetic field caused as rotating relative to the magnetic member. The processing unit is capable of processing output values of the sensor element. The processing unit acquires the output value at every angle of rotation of the rotating object, estimates a waveform for one cycle of the signals as an estimation waveform from the acquired output values, and normalizes an amplitude of the estimation waveform. Further, the processing unit calculates a rotational angle of the rotating object by a trigonometric function operation based on the output value and the normalized amplitude.

### CROSS REFERENCE TO RELATED APPLICATION

This application is based on Japanese Patent Application No. 2010-74423 filed on Mar. 29, 2010, the disclosure of which is incorporated herein by reference.

### FIELD OF THE INVENTION

The present invention relates to a rotational angle detecting device for detecting a rotational angle of a rotating object.

### BACKGROUND OF THE INVENTION

In a conventional rotational angle detecting device, one of a magnetic member such as a magnet for generating a magnetic field and a magnetic sensor such as a Hall element is disposed on a rotating object. The magnetic field of the magnetic member is sensed by the magnetic sensor to detect a rotational angle of the rotating object.

For example, in a rotational angle detecting device described in Japanese Patent Application Publication No. 2008-051638, which corresponds to US2008/0048651, a rotational angle of a rotating object is calculated based on output values outputted from two Hall elements by a trigonometric function operation. Although signals are outputted from both the Hall elements, if the rotational angle detecting device is used for detecting a rotational angle of a rotating object whose operation angle is relatively small, such as an electronic throttle and an accelerator pedal, each of waveforms of the outputted signals cannot be obtained for one cycle. Therefore, it is difficult to detect the maximum value of the waveform, that is, an amplitude of the waveform. Further, it is difficult to accord the amplitudes of the two waveforms, and thus errors of detected rotational angles will increase. In other words, the amplitudes of the two waveforms cannot be adjusted in each product in which the magnetic member and the magnetic sensor are combined. Therefore, it is difficult to reduce unevenness of detection results in each product.

Further, in a magnetic circuit passing through an axis as described in Publication No. 2008-051638, if magnetosensitive surfaces of the Hall elements are displaced even slightly, phases and amplitudes of the outputted signals are largely varied, resulting in an increase in unevenness of the detection results in each product.

For example, in a rotational angle detecting device described in Japanese Patent Application Publication No. 2001-124511, which corresponds to U.S. Pat. No. 6,498,479, a rotational angle of a rotating object is calculated based on output values outputted from a single Hall element by a trigonometric function operation. Further, the rotational angle of the rotating object is calculated using the maximum value of signals outputted from the Hall element. Therefore, if the rotational angle detecting device is used to detect a rotational angle of a rotating object whose rotational angle is relatively small, such as an electronic throttle or an acceleration pedal, it is difficult to detect the maximum value of the signals. In such a case, it is difficult to normalize a waveform of the signals, and thus errors of the detected rotational angles will increase. As such, similar to the rotational angle detecting device described in Publication No. 2008-051638, it is difficult to reduce unevenness of the detection results in each product.

### SUMMARY OF THE INVENTION

The present invention is made in view of the foregoing matter, and it is an object of the present invention to provide a rotational angle detecting device capable of reducing errors of detection results and improving detection accuracy.

According to an aspect, a rotational angle detecting device includes a magnetic member, a magnetic sensor, and a processing unit. The magnetic member generates a magnetic field. The magnetic sensor includes a sensor element that is disposed to rotate relative to the magnetic member in accordance with a rotation of a rotating object, and outputs signals according to a change in the magnetic field caused as rotating relative to the magnetic member. The processing unit is capable of processing output values of the sensor element.

The processing unit acquires the output value at every angle of rotation of the rotating object, estimates a waveform for one cycle of the signals outputted from the sensor element as an estimation waveform from the acquired output values, and normalizes an amplitude of the estimation waveform. Further, the processing unit calculates a rotational angle of the rotating object by a trigonometric function operation based on the output value and the normalized amplitude.

Since the waveform for one cycle is estimated, that is, the estimation waveform is generated, and the amplitude of the estimation waveform is normalized before the calculation of the rotational angle, unevenness of detection results of each product of the rotational angle detecting device is reduced. As such, errors of detection results reduce and detection accuracy improves.

According to another aspect, a rotational angle detecting device includes a magnetic member, a magnetic sensor and a processing unit. The magnetic member generates a magnetic field. The magnetic sensor includes a first sensor element and a second sensor element that are disposed to rotate relative to the magnetic member in accordance with a rotation of the rotating object, and respectively output first signals and second signals according to a change in a magnetic field caused as rotating relative to the magnetic member. The processing unit is capable of processing first output values of the first sensor element and second output values of the second sensor element.

The processing unit acquires the first output value and the second output value at every angle of rotation of the rotating object, estimates a waveform for one cycle of the first signals as a first estimation waveform and a waveform for one cycle of the second signals as a second estimation waveform from the acquired first output values and the acquired second output values, and adjusts an amplitude of the first estimation waveform and an amplitude of the second estimation waveform to be equal. Further, the processing unit calculates a rotational angle of the rotating object by a trigonometric function operation based on the first output value, the second output value, and the adjusted amplitude of the first and second estimation waveforms.

Since the first estimation waveform and the second estimation waveform are generated, and amplitudes of the first and second estimation waveforms are adjusted to be equal before the calculation of the rotational angle. Therefore, unevenness of detection results in each product of the rotational angle detecting device is reduced. Accordingly, errors of the detection results reduce, and detection accuracy improves.

### BRIEF DESCRIPTION OF THE DRAWINGS

Other objects, features and advantages of the present invention will become more apparent from the following detailed description made with reference to the accompanying drawings, in which like parts are designated by like reference numbers and in which:

FIG. 1A is a schematic diagram of a rotational angle detecting device according to a first embodiment of the present invention;

FIG. 1B is a side view of the rotational angle detecting device when viewed along an arrow IB in FIG. 1A;

FIG. 2 is a schematic diagram of a magnetic sensor of the rotational angle detecting device according to the first embodiment;

FIG. 3 is a graph showing outputs of a sensor element of the magnetic sensor according to the first embodiment;

FIG. 4A is a graph showing a magnetic flux density adjacent to the sensor element according to the first embodiment;

FIG. 4B is a graph showing outputs of the sensor element according to the first embodiment;

FIG. 5A is a graph showing outputs of the sensor element according to the first embodiment;

FIG. 5B is a graph showing an estimation waveform according to the first embodiment;

FIG. 6A is a graph showing an estimation waveform after amplitude normalization according to the first embodiment;

FIG. 6B is a graph showing a calculated rotational angle according to the first embodiment;

FIG. 7A is a schematic diagram of a rotational angle detecting device according to a second embodiment of the present invention;

FIG. 7B is a side view of the rotational angle detecting device when viewed along an arrow VIIB in FIG. 7A;

FIG. 8 is a graph showing outputs of a sensor element of the rotational angle detecting device according to the second embodiment;

FIG. 9A is a graph showing a magnetic flux density adjacent to the sensor element according to the second embodiment;

FIG. 9B is a graph showing outputs of the sensor element according to the second embodiment;

FIG. 10A is a graph showing outputs of the sensor element according to the second embodiment;

FIG. 10B is a graph showing an estimation waveform according to the second embodiment;

FIG. 11A is a graph showing an estimation waveform after amplitude normalization according to the second embodiment;

FIG. 11B is a graph showing a calculated rotational angle according to the second embodiment;

FIG. 12A is a schematic diagram of a rotational angle detecting device according to a third embodiment of the present invention;

FIG. 12B is a side view of the rotational angle detecting device when viewed along an arrow XIIB in FIG. 12A;

FIG. 13 is a schematic diagram of a magnetic sensor of the rotational angle detecting device according to the third embodiment;

FIG. 14A is a graph showing outputs of a first sensor element of the rotational angle detecting device according to the third embodiment;

FIG. 14B is a graph showing outputs of a second sensor element of the rotational angle detecting device according to the third embodiment;

FIG. 15A is a graph showing magnetic flux densities adjacent to the first and second sensor elements according to the third embodiment;

FIG. 15B is a graph showing outputs of the first and second sensor elements according to the third embodiment;

FIG. 16A is a graph showing outputs of the first and second sensor elements according to the third embodiment;

FIG. 16B is a graph showing a first estimation waveform and a second estimation waveform according to the third embodiment;

FIG. 17A is a graph showing a first estimation waveform and a second estimation waveform after amplitude normalization according to the third embodiment;

FIG. 17B is a graph showing a calculated rotational angle according to the third embodiment;

FIG. 18A is a schematic diagram of a rotational angle detecting device according to a fourth embodiment of the present invention; and

FIG. 18B is a side view of the rotational angle detecting device when viewed along an arrow XVIIIB in FIG. 18A.

### DETAILED DESCRIPTION OF EXEMPLARY EMBODIMENTS

Exemplary embodiments will be described hereinafter with reference to the accompanying drawings. Like parts are designated by like reference numbers throughout the embodiments, and a description thereof will not be repeated.

### First Embodiment

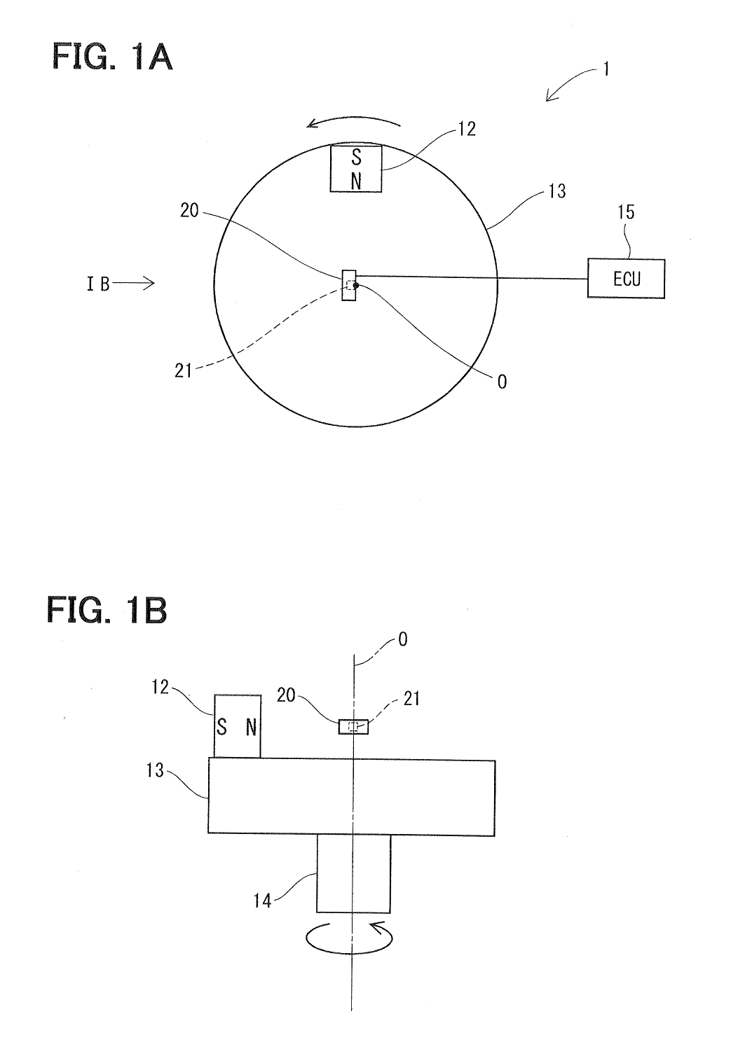

A rotational angle detecting device 1 according to a first embodiment is shown in FIGS. 1A and 1B. The rotational angle detecting device 1 is configured to detect a rotational angle of a valve shaft of an electronic throttle as an example of a rotating object. The rotational angle detecting device 1 generally includes a permanent magnet 12 as an example of a magnetic member, a Hall IC 20 as an example of a magnetic sensor, an electronic control circuit (ECU) 15, and the like.

The permanent magnet 12 is disposed on a surface of a disc-shaped support member 13. A rotation shaft 14 is connected to an opposite surface of the support member 13. The permanent magnet 12 is located at an outer end portion of the support member 13, and is magnetized in a radial direction of the support member 13. Thus, the permanent magnet 12 rotates about a central axis O of the rotation shaft 14 in accordance with a rotation of the rotating object.

The Hall IC 20 is located at a substantially center of the support member 13, on the same side as the permanent magnet 12, that is, on the opposite side of the rotation shaft 14. The Hall IC 20 is located inside of a circular path of the permanent magnet 12 that rotates with the support member 13. That is, the Hall IC 20 is disposed to rotate relative to the permanent magnet 12 in accordance with the rotation of the rotating object.

The Hall IC 20 has a Hall element 21 as an example of a sensor element for sensing a magnetic field. The Hall IC 20 is a magnetic sensor in which the Hall element 21 and other components are mounted in a single semiconductor chip. The Hall IC 20 is disposed such that a magnetosensitive surface of the Hall element 21 is located on the central axis O. The Hall element 21 output signals according to a change in the magnetic field caused as rotating relative to the permanent magnet 12. In a condition of being mounted in the semiconductor chip, the Hall element 21 is adjusted such that an offset thereof is zero.

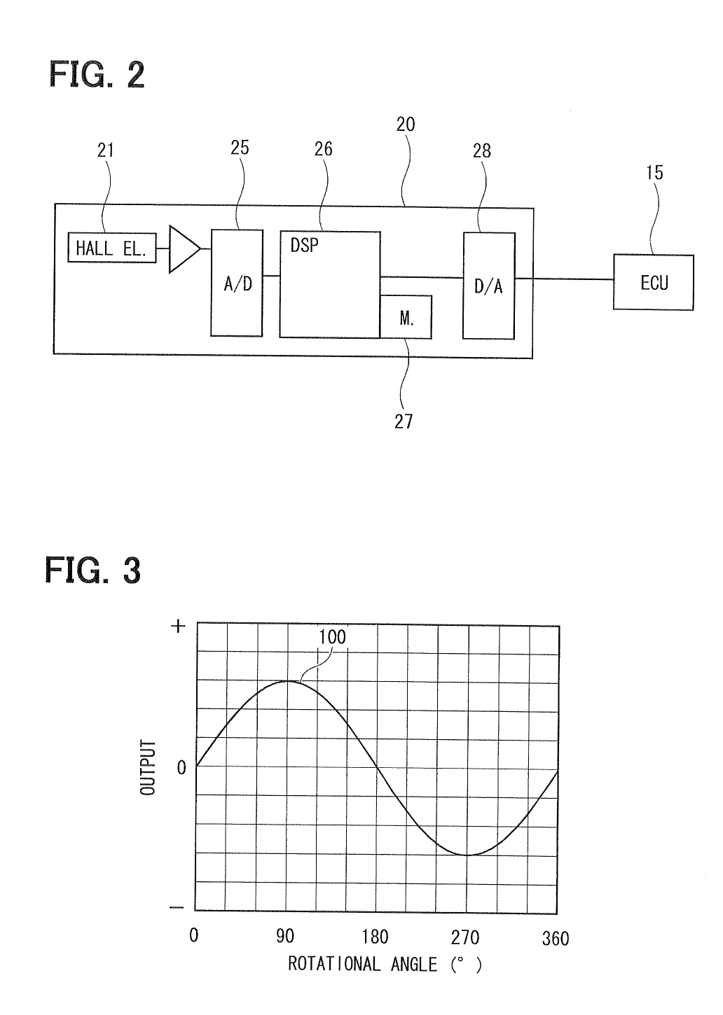

The ECU 15 includes a CPU, a memory, and the like. The ECU 15 performs various processing by executing various programs stored in the memory. As shown in FIG. 2, the Hall IC 20 includes the Hall element 21, an A/D converter 25, a digital signal processor (DSP) 26, a memory 27, and a D/A converter 28. The Hall element 21, the A/D converter 25, the DSP 26, the memory 27 and the D/A converter 28 are mounted in the single semiconductor chip.

The A/D converter 25 coverts analog signals outputted from the Hall element 21 into digital signals and transmits the digital signals to the DSP 26. The DSP 26 processes output values obtained from the Hall element 21 by executing various programs stored in the memory 27. The DSP 26 further transmits the processed results to the D/A converter 28. The D/A converter 28 converts the digital signals from the DSP 26 into analog signals and transmits the analog signals to the ECU 15. For example, the Hall IC 20 and the ECU 15 serve as a processing unit. Various processing executed by the ECU 15 and the DSP 26 will be described later in detail.

In the present embodiment, the Hall element 21 is located on the central axis O. For example, when the permanent magnet 12 rotates 360 degrees about the Hall IC 20, the Hall element 21 outputs signals as shown by a signal curve 100 in FIG. 3. In this case, the signal curve 100 accords with a sinusoidal wave having a cycle of 360 degrees. That is, it can be said that the signal curve 100 is an exact sinusoidal wave. Therefore, the signal curve 100 is, for example, expressed as A×sin(kθ), in which k=1.

Hereafter, a prior setup of the Hall IC 20 will be described. In the present embodiment, “output value acquisition”, “waveform estimation” and “amplitude normalization” are performed as tasks of the prior setup.

<Output Value Acquisition>

In the stage of output value acquisition, the ECU 15 acquires a value outputted from the Hall element 21 at every angle of rotation of the rotating object. In this case, the ECU 15 acquires the values from the Hall element 21 via the A/D converter 25, the DSP 26 and the D/A converter 28. The A/D converter 25, the DSP 26, the D/A converter 28 and the ECU 15 constitute an output value acquiring section. In this application, the value outputted from the Hall element 21 is simply referred to as the output value.

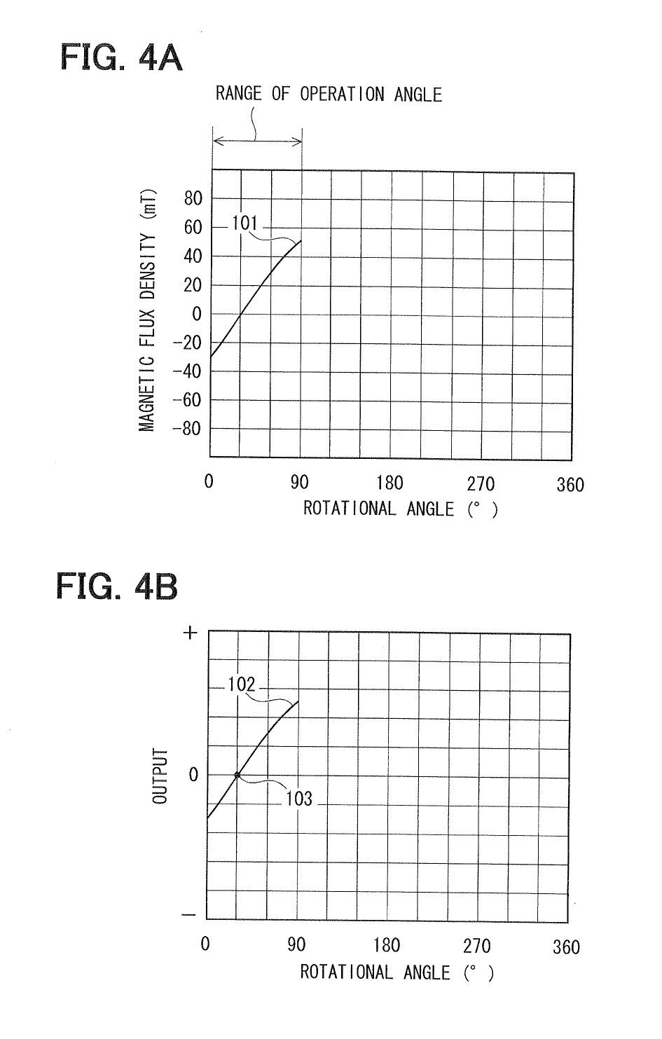

In the present embodiment, the rotating object is the valve shaft of the electronic throttle. A range of operation angle of the valve shaft is, for example from 0 to 90 degrees. Therefore, a magnetic flux density around the Hall element 21 is created as shown by a curve 101 of FIG. 4A. Further, the output values are indicated by points on a curve 102 of FIG. 4B.

In the stage of the output value acquisition, the ECU 15 acquires the output value of each angle of rotation of the rotating object, in such a manner that “the output value is −29 when the rotational angle of the rotating object is 0 degree”, “the output value is −28 when the rotational angle of the rotating object is 1 degree” . . . . Since the range of the operation angle of the rotating object is from 0 to 90 degrees, the output values are obtained in a range from 0 to 90 degrees, as shown in FIG. 4B.

If the range of the rotational angle of the rotating object is sufficiently large, a waveform can be indicated over one cycle by the output values. In the present embodiment, however, the waveform is indicated for a 1/4 cycle. Therefore, at this stage, the maximum value of the waveform, that is, an amplitude of the waveform indicated by the output values is indistinct.

In the present embodiment, the permanent magnet 12 and the Hall IC 20 are arranged beforehand to have a positional relationship so that a rotational angle where the output value is zero is included. Therefore, value “0” is included in the output values, as shown by a point 103 of FIG. 4B.

<Waveform Estimation>

As described above, the amplitude of the waveform indicated by the output values is indistinct, in the stage of the output value acquisition. Therefore, in the stage of waveform estimation, the ECU 15 estimates one cycle of the waveform indicated by the output values to calculate the amplitude of the waveform. In the present embodiment, the waveform for one cycle is also referred to as “estimation waveform”. The ECU 15 serves as a waveform estimating section, that is, an estimation waveform generating section.

Hereinafter, a method of estimating the waveform for one cycle, that is, a method of generating the estimation waveform will be described.

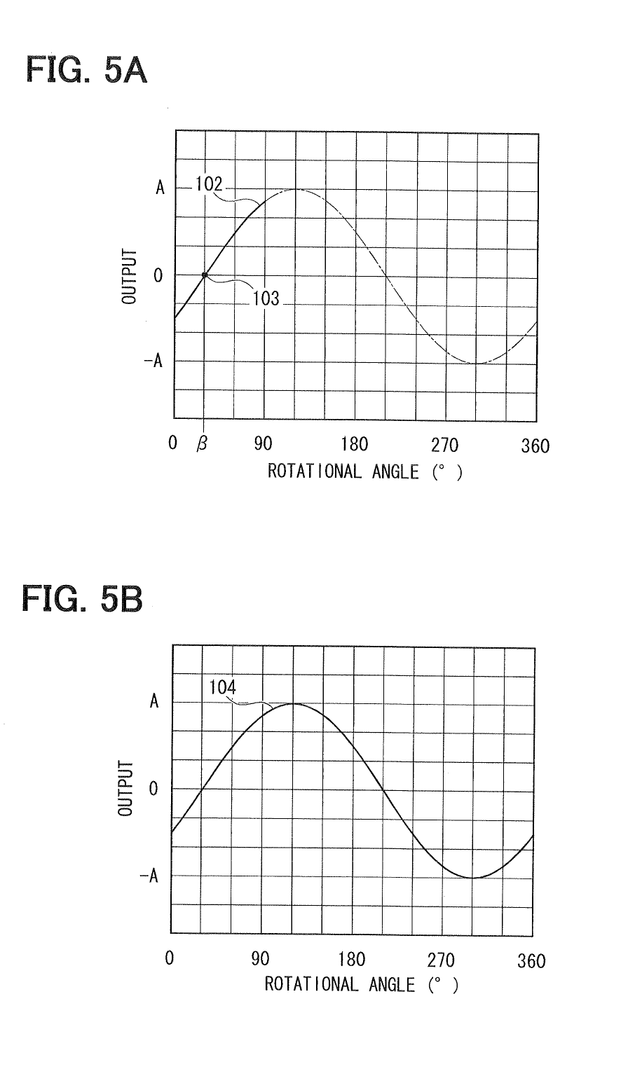

A phase of the estimation waveform is calculated from the point 103 where the output value is zero, as shown in FIG. 5A. In the present embodiment, an angle at the point 103 is β, and thus the phase of the estimation waveform is defined as β. Assuming that the amplitude of the estimation waveform is A, the estimation waveform is expressed as A×sin(k(θ−β)). Here, k is a coefficient for correcting the cycle in a case where the signals outputted from the Hall element 21 do not indicate the exact sinusoidal wave.

In the present embodiment, the coefficient k is one (k=1), since the Hall element 21 is disposed on the central axis O and the output signals from the Hall element 21 indicate the exact sinusoidal wave having the cycle of 360 degrees as shown by the signal curve 100 in FIG. 3. In the following expressions, therefore, k is indicated for the sake of convenience.

The amplitude A of the estimation waveform is calculated by a least squares method. Assuming that the output of the Hall element 21 is Va(θi) and the waveform of the estimation waveform is A×sin(kθi), A×sin θi most approximates to Va(θi) when a following expression (1) is satisfied:

$${K}^{2} ( A ) = {\sum }_{i = 1}^{n} {( Va ( θ i ) - A \times sin ( k θ i ) )}^{2} = Min \qquad ( 1 )$$

Because K²(A) is a quadratic function, K²(A) is the minimum value (Min) when an inclination at an inflection point of the K²(A) is zero, that is, when the differentiation of K²(A) is zero. Therefore,

$$\begin{matrix}{( {K}^{2} ( A ) )}^{′} = ( {\sum }_{i = 1}^{n} {( Va ( θ i ) - A \times {sin ( k θ i )}^{2} )}^{′} \\ = {( \sum ( {Va}^{2} ( θ i ) - 2 A \times Va ( θ i ) sin ( k θ i ) + {A}^{2} {sin}^{2} ( k θ i ) ) )}^{′} \\ = \sum ( - 2 Va ( θ i ) sin ( k θ i ) + 2 A \times {sin}^{2} ( k θ i ) ) \\ = 0\end{matrix} \qquad ( 2 )$$

From the expression (2),

Σ(Va(θi)sin(kθi))=AΣ(sin²(kθi)) (3)

From the expression (3),

A=Σ(Va(θi)sin(kθi))/Σ(sin²(kθi)) (4)

In the present embodiment, the coefficient k is 1.

A=Σ(Va(θi)sin θi)/Σ(sin² θi) (5)

Accordingly, the estimation waveform is obtained as shown by a curve 104 of FIG. 5B.

<Amplitude Normalization>

In the stage of amplitude normalization, the ECU 15 normalizes the amplitude of the estimation waveform so that the amplitude of the estimation waveform becomes 1. Here, the ECU 15 serves as an amplitude normalizing section.

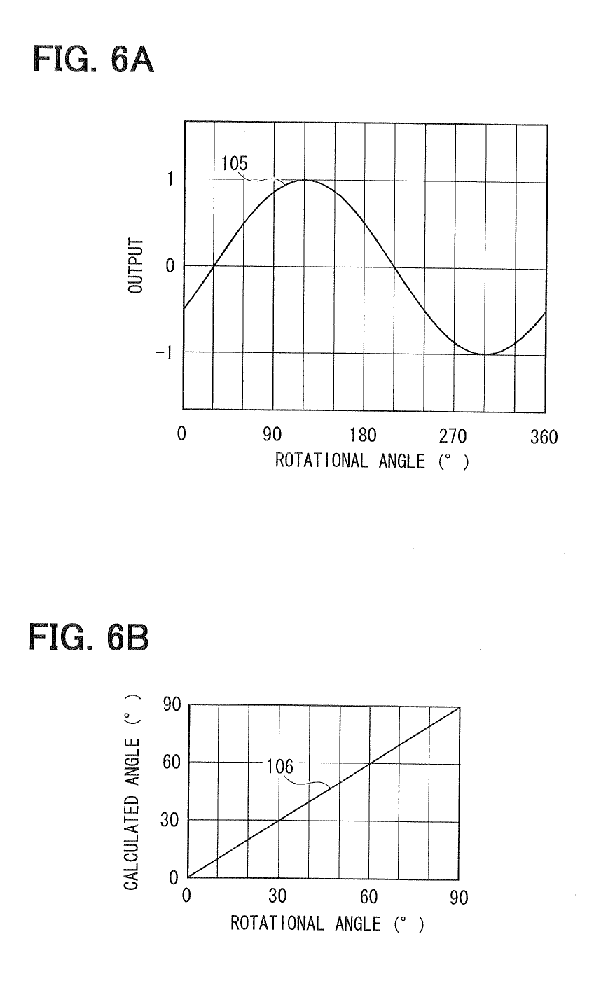

For example, the estimation waveform is divided by A to make the amplitude of the estimation waveform 1. Thus, the estimation waveform after the amplitude thereof is normalized is shown by a curve 105 of FIG. 6A.

In this way, the prior setup of the Hall IC 20 is performed.

Next, a method of detecting a rotational angle of the rotating object by the rotational angle detecting device 1 will be described. In the present embodiment, “rotational angle calculation” is performed to detect the rotational angle of the rotating object.

<Rotational Angle Calculation>

In the stage of rotational angle calculation, the DSP 26 calculates a rotational angle of the rotating object by a trigonometric function operation based on the output value of the Hall element 21 and the amplitude of the estimation waveform, which has been normalized to 1 by the amplitude normalizing section. Here, the DSP 26 serves a rotational angle calculating section.

Assuming that the output value of the Hall element 21 is Va, an atmospheric temperature of the Hall element 21 is t, a coefficient of temperature characteristic is K(t), a coefficient of temperature characteristic with regard to an electric current is I(t), a coefficient of temperature characteristic with regard to the magnetic flux density is Ba(t), and the rotational angle of the rotating object is θ,

Va=K(t)×I(t)×Ba(t)×sin(θ−β) (6)

In the present embodiment, the estimation waveform is estimated as A×sin(θ−β) in the stage of the waveform estimation, and the amplitude of the estimation waveform is normalized to 1 in the stage of the amplitude normalization. Therefore, the rotational angle θ is calculated from the following expression (7):

θ=180°/Π×sin⁻¹(Va/A)+β (7)

The DSP 26 receives the output value Va from the Hall element 21, and calculates the rotational angle θ of the rotating object, as shown by a line 106 in FIG. 6B, by the trigonometric function operation using the expression (7) based on the output value Va.

It is to be noted that, in the present embodiment, the estimation waveform can be regarded as a cosine wave. Therefore, the rotational angle θ can be also calculated by the following expression (8):

θ=180°/Π×cos⁻¹(Va/A)+β (8)

As described in the above, in the present embodiment, the rotational angle θ is calculated based on the trigonometric function operation by the rotational angle calculating section after estimating the estimation waveform by the waveform estimating section and normalizing the amplitude of the estimation waveform to 1 by the amplitude normalizing section. That is, the estimation of the waveform by the waveform estimating section and the normalization of the amplitude by the amplitude normalizing section are performed beforehand. Therefore, unevenness of detection results of each product of the rotational angle detecting device 1 can be reduced. Therefore, the error of detection results reduces, and hence detection accuracy improves.

The permanent magnet 12 and the Hall IC 20 have the positional relationship so that the rotational angle where the output value of the Hall element 21 is zero is included. Therefore, the output values approximate to zero can be used to estimate the estimation waveform. With this, an S/N ratio of the Hall element 21 improves and the phase of the estimation waveform is easily determined. Accordingly, the estimation of the waveform by the waveform estimating section can be accurately performed.

The Hall element 21 is adjusted so that the offset thereof is zero. Therefore, since there is no offset even in a condition of being combined with the permanent magnet 12, the estimation of the waveform by the waveform estimating section can be further accurately performed.

In estimating the estimation waveform, the waveform estimating section calculates the phase of the estimation waveform from the point where the output value is zero and calculates the amplitude of the estimation waveform by the least squares method. As such, the estimation waveform can be accurately estimated. As a result, the rotational angle θ can be accurately calculated by the rotational angle calculating section.

The Hall element 21, the DSP 26 serving as the output value acquiring section and the rotational angle calculating section, and the like are mounted in the single semiconductor chip. Since the Hall element 21, the DSP 26 and the like are mounted in the single semiconductor chip, an overall size of the rotational angle detecting device can be reduced.

In this way, even in the case where the signals cannot be obtained through one cycle due to the rotational angle of the rotating object being small, the rotational angle can be accurately detected.

### Second Embodiment

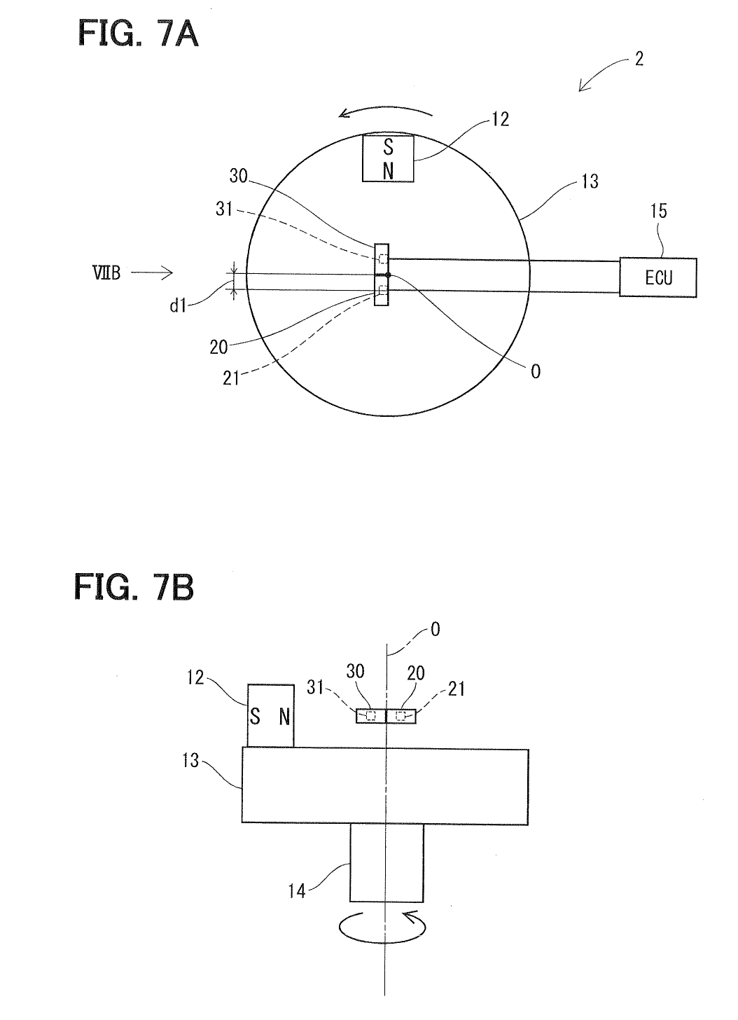

A second embodiment will be described with reference to FIG. 7A to FIG. 11B. Referring to FIGS. 7A and 7B, a rotational angle detecting device 2 according to the first embodiment is different from the rotational angle detecting device 1 of the first embodiment in view of a physical structure. That is, the rotational angle detecting device 2 has a Hall IC for a backup detection, in addition to the Hall IC 20 for detecting the rotational angle, and thus the Hall ICs are arranged in a different manner from that of the first embodiment.

As shown in FIGS. 7A and 7B, the rotational angle detecting device 2 has a Hall IC 30, in addition to the Hall IC 20. The Hall IC 20 and the Hall IC 30 are arranged on opposite sides of the central axis O. The Hall IC 30 has a Hall element 31. The Hall element 31 is opposed to the Hall element 21 with respect to the central axis O.

The Hall IC 30 is employed as backup of the Hall IC 20. That is, in a normal condition, the magnetic field is detected by the Hall IC 20. If an abnormal condition arises and where the Hall IC 20 cannot detect the magnetic field, the Hall IC 30 detects the magnetic field. In the present embodiment, the Hall IC 20 serves as the magnetic sensor, and the Hall element 21 serves as the sensor element. The Hall IC 30 has an internal structure similar to the internal structure of the Hall IC 20.

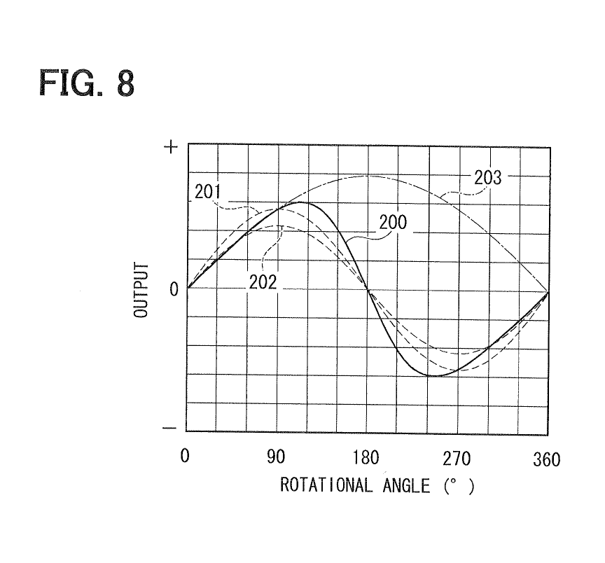

Both of the Hall IC 20 and the Hall IC 30 are located adjacent to the central axis O. Therefore, the magnetosensitive surface of the Hall element 21 is spaced from the central axis O by a predetermined distance d1. In such a structure, for example, when the permanent magnet 12 rotates 360 degrees around the Hall IC 20, the signals outputted from the Hall element 21 are indicated by a signal curve 200 of FIG. 8.

In FIG. 8, a curve 201 and a curve 202 both indicate sinusoidal waves each having a cycle of 360 degrees. The signal curve 200 accords with neither the curve 201 nor the curve 202. That is, it is understood that the signal curve 200 does not indicate an exact sinusoidal wave. In FIG. 8, a curve 203 is a sinusoidal wave sin(kθ) with a cycle of 360/k degrees. The signal curve 200 approximately accords with the curve 203 in a range from zero to its maximum value.

In consideration of the above matters, a prior setup of the Hall IC 20 of the present embodiment will be performed in the following manner. In the present embodiment, “output value acquisition”, “waveform estimation” and “amplitude normalization” are performed as tasks of the prior setup, in the similar manner to the first embodiment.

<Output Value Acquisition>

In the stage of output value acquisition, the ECU 15 acquires a value outputted from the Hall element 21 at every angle of rotation of the rotating object. Hereinafter, the value outputted from the Hall element 21 is also simply referred to as the output value.

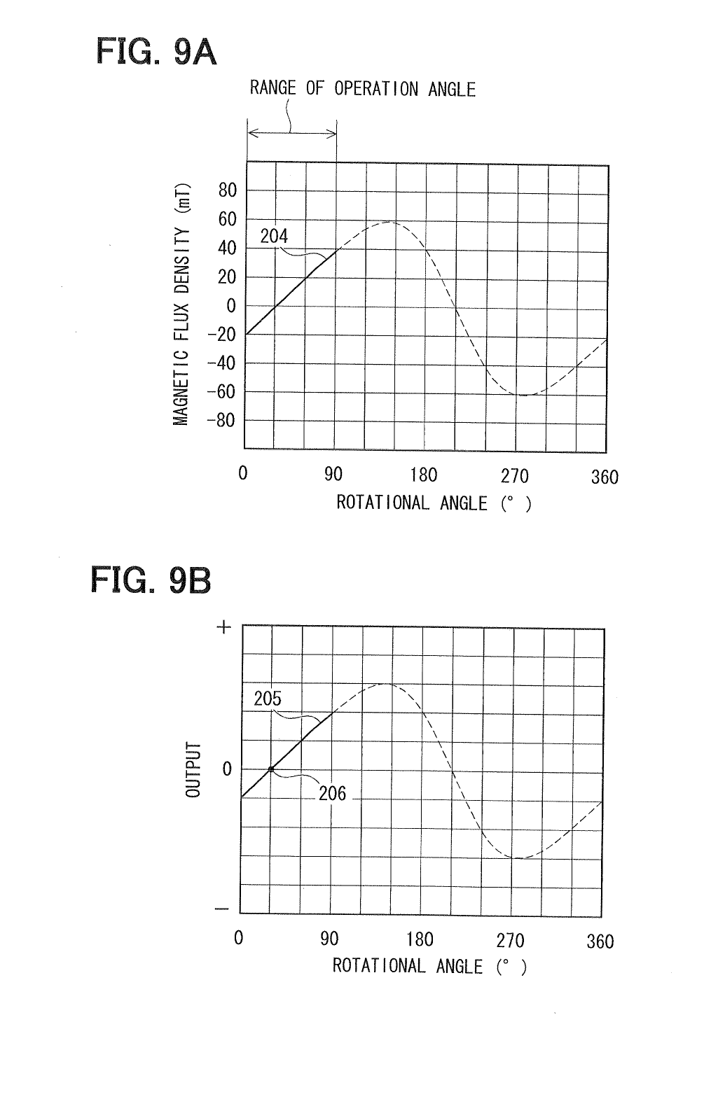

In the present embodiment, the rotating object is the valve shaft of the electronic throttle. Thus, a range of operation angle of the valve shaft is, for example from 0 to 90 degrees. Therefore, a magnetic flux density around the Hall element 21 is created as shown by a curve 204 of FIG. 9A. Further, the output values are expressed by points on a curve 205 of FIG. 9B.

Since the range of the operation angle of the rotating object is from 0 to 90 degrees, the output values are obtained in a range from 0 to 90 degrees, as shown in FIG. 9B. If the range of the rotational angle of the rotating object is sufficiently large, a waveform can be indicated over one cycle by the output values. In the present embodiment, however, the waveform is indicated for a 1/4 cycle. Therefore, at this stage, the maximum value of the waveform, that is, an amplitude of the waveform indicated by the output values is indistinct.

In the present embodiment, the permanent magnet 12 and the Hall IC 20 are arranged beforehand in a such a manner that the rotational angle where the output value is zero is included. Therefore, value “0” is included in the output values, as shown by a point 206 of FIG. 9B.

<Waveform Estimation>

As described above, the amplitude of the waveform indicated by the output values is indistinct in the stage of the output value acquisition. Therefore, in the stage of waveform estimation, the ECU 15 estimates one cycle of the waveform indicated by the output values to calculate the amplitude of the waveform. Hereinafter, the waveform for one cycle is also referred to as “estimation waveform”.

Hereinafter, a method of estimating the estimation waveform, that is, a method of generating the estimation waveform will be described.

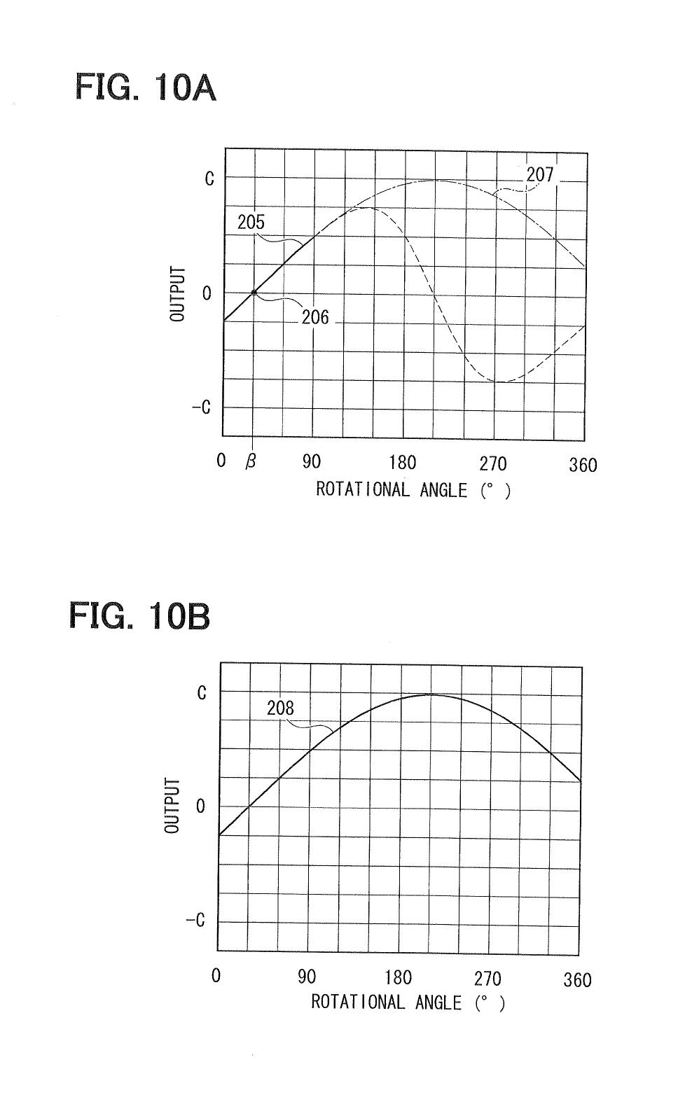

A phase of the estimation waveform is calculated from the point 206 where the output value is zero, as shown in FIG. 10A. In the present embodiment, an angle at the point 206 is β, and thus the phase of the estimation waveform is defined as β. Assuming that the amplitude of the waveform is C, the estimation waveform is expressed as C×sin(k(θ−β)) and shown by a curve 207 of FIG. 10A.

Here, k is a coefficient for correcting the cycle in a case where the signals outputted from the Hall elements 21 do not indicate the exact sinusoidal wave. In the present embodiment, since the Hall element 21 is not located on the central axis O, the signals outputted from the Hall element 21 do not indicate the exact sinusoidal wave, as shown by the signal curve 200 of FIG. 8. In this case, therefore, the cycle is corrected by defining the estimation waveform as C×sin(k(θ−β)), in which k is not equal to one (k≠1).

The amplitude C of the estimation waveform is calculated by a least squares method. Assuming that the output of the Hall element 21 is Va(θi), and the waveform of the estimation waveform is C×sin(kθi), the following expression (9) is obtained based on the above expressions (1) through (4):

C=Σ(Va(θi)sin(kθi))/Σ(sin²(kθi)) (9)

Accordingly, the estimation waveform is obtained as shown by a curve 208 of FIG. 10B.

<Amplitude Normalization>

In the stage of amplitude normalization, the ECU 15 normalizes the amplitude of the estimation waveform to 1.

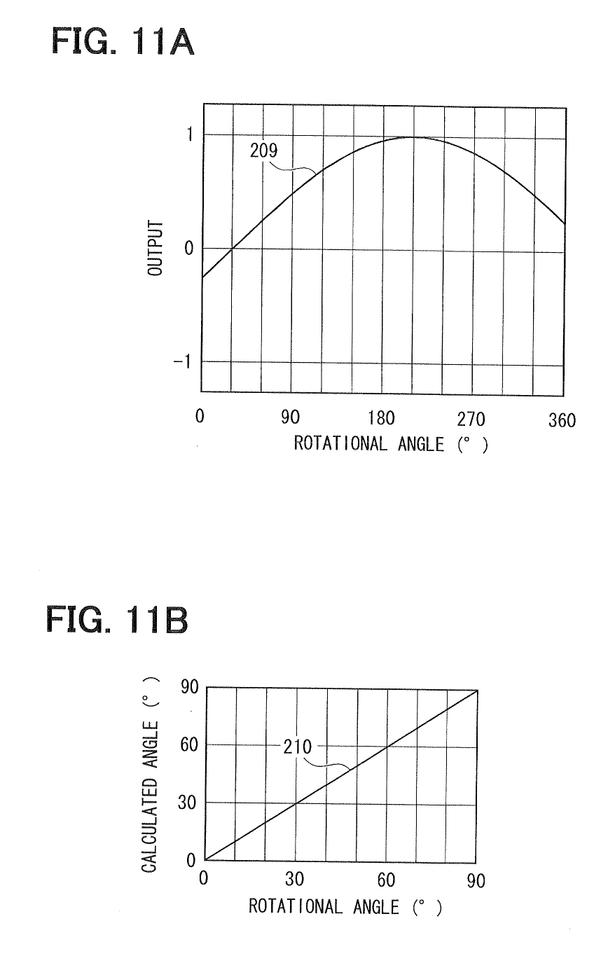

For example, the estimation waveform is divided by C to make the amplitude of the estimation waveform 1. Thus, the estimation waveform after the amplitude thereof is normalized is shown by a curve 209 of FIG. 11A.

In this way, the prior setup of the Hall IC 20 is performed.

Next, a method of detecting a rotational angle of the rotating object by the rotational angle detecting device 2 will be described. In the present embodiment, “rotational angle calculation” is performed to detect the rotational angle of the rotating object.

<Rotational Angle Calculation>

In the stage of rotational angle calculation, the DSP 26 calculates the rotational angle of the rotating object by a trigonometric function operation based on the output value of the Hall element 21 and the amplitude 1 of the estimation waveform normalized by the amplitude normalizing section.

Assuming that the output value of the Hall element 21 is Va, an atmospheric temperature of the Hall element 21 is t, a coefficient of temperature characteristic is K(t), a coefficient of temperature characteristic with regard to an electric current is I(t), a coefficient of temperature characteristic with regard to the magnetic flux density is Ba(t), and the rotational angle of the rotating object is θ,

Va=K(t)×I(t)×Ba(t)×sin(k(θ−β)) (10)

In the present embodiment, the estimation waveform is estimated as C×sin(kθ−β) in the sage of the waveform estimation, and the amplitude of the estimation waveform is adjusted to 1 in the stage of the amplitude normalization. Therefore, the rotational angle θ is calculated from the following expression (11):

θ=(180°/Π×sin⁻¹(Va/C))/k+β (11)

The DSP 26 receives the output value Va from the Hall element 21, and calculates the rotational angle θ of the rotating object, as shown by a line 210 in FIG. 11B, by the trigonometric function operation of the expression (11) based on the output value Va.

In the present embodiment, the estimation waveform can be regarded as a cosine wave. Therefore, the rotational angle θ can be calculated by the following expression (12):

θ=(180°/Π×cos⁻¹(Va/C))/k+β (12)

As described in the above, in the present embodiment, the rotational angle of the rotating object is calculated based on the trigonometric function operation by the rotational angle calculating unit after correcting the cycle of the signals outputted from the Hall element 21. That is, the estimation waveform is estimated after correcting the cycle so that the signals outputted from the Hall element 21 indicate the exact sinusoidal wave, and then the rotational angle is detected using the estimation waveform. Accordingly, in the present embodiment, the rotational angle of the rotating object can be accurately detected, irrespective of the positional relationship between the permanent magnet 12 and the Hall IC 20.

Further, in the case where the Hall IC 20 cannot detect the magnetic field due to a malfunction or the like, the magnetic field can be detected using the backup Hall IC 30 in the similar manner as the detection by the Hall IC 20.

### Third Embodiment

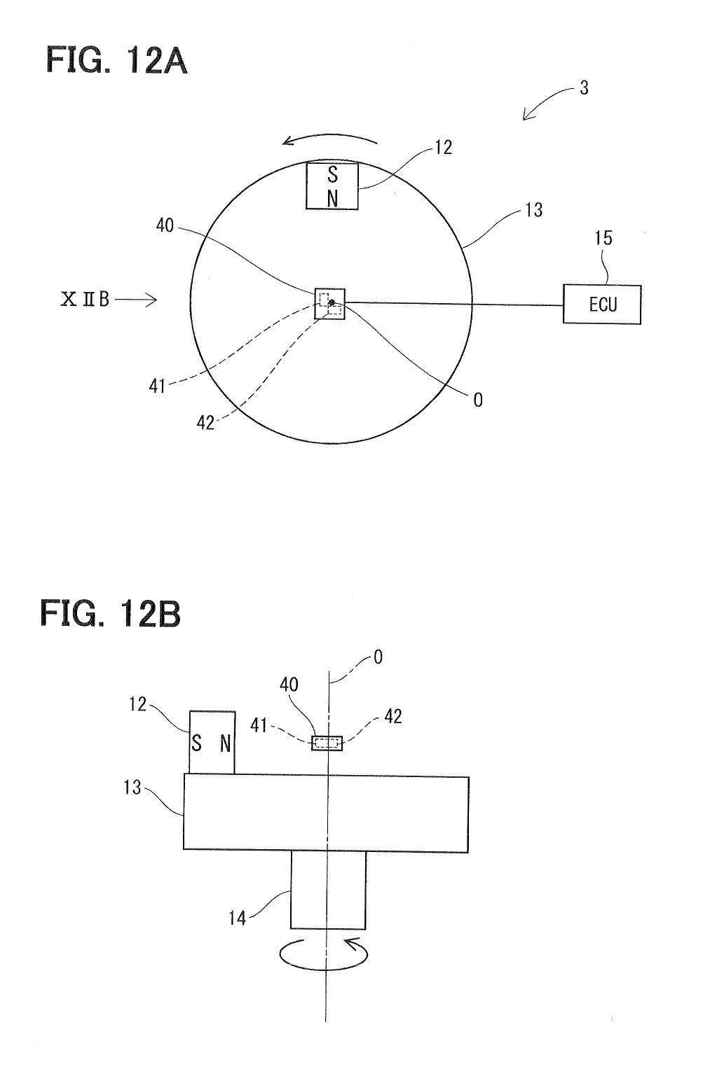

A third embodiment will be described with reference to FIGS. 12A through 17B. A rotational angle detecting device 3 according to the third embodiment is different from the rotational angle detecting device 1 according to the first embodiment because a single magnetic sensor includes two sensor elements.

For example, the rotational angle detecting device 3 includes a Hall IC 40 as an example of the magnetic sensor, and the Hall IC 40 includes a first Hall element 41 and a second Hall element 42 as examples of first and second sensor elements for sensing magnetic fields.

Similar to the Hall IC 20 of the first embodiment, the Hall IC 40 is disposed at a substantially center of the support member 13, on an opposite side as the rotation shaft 14. The Hall IC 40 is a magnetic sensor in which the first Hall element 41, the second Hall element 42 and other components are mounted in a single semiconductor chip.

The Hall IC 40 is disposed such that a magnetosensitive surface of the first Hall element 41 and a magnetosensitive surface of the second Hall element 42 are located on the central axis O. Further, the magnetosensitive surface of the first Hall element 41 and the magnetosensitive surface of the second Hall element 42 form a predetermined angle therebetween. Each of the first Hall element 41 and the second Hall element 42 output signals according to a change in the magnetic field caused as rotating relative to the permanent magnet 12. In a condition of being mounted in the semiconductor chip, the first Hall element 41 and the second Hall element 42 are adjusted such that offsets thereof are zero.

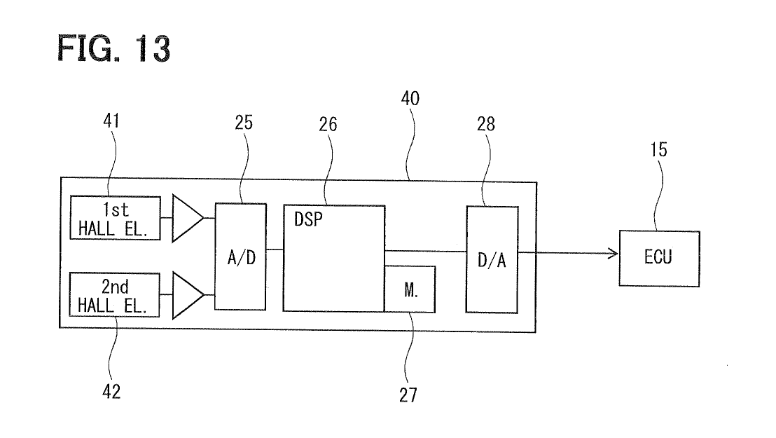

As shown in FIG. 13, the Hall IC 40 is constructed as the single semiconductor chip in which the first Hall element 41, the second Hall element 42, the A/D converter 25, the digital signal processor (DSP) 26, the memory 27, and the D/A converter 28 are mounted. The A/D converter 25 coverts analog signals outputted from the first Hall element 41 and the second Hall element 42 into digital signals and transmits the digital signals to the DSP 26. The DSP 26 processes the output values of the first Hall element 41 and the second Hall element 42 by executing various programs stored in the memory 27. The DSP 26 further transmits the processed results to the D/A converter 28. The D/A converter 28 converts the digital signals from the DSP 26 into analog signals and transmits the analog signals to the ECU 15. The Hall IC 40 and the ECU 15 serve as a processing unit. Various processing executed by the ECU 15 and the DSP 26 will be described later in detail.

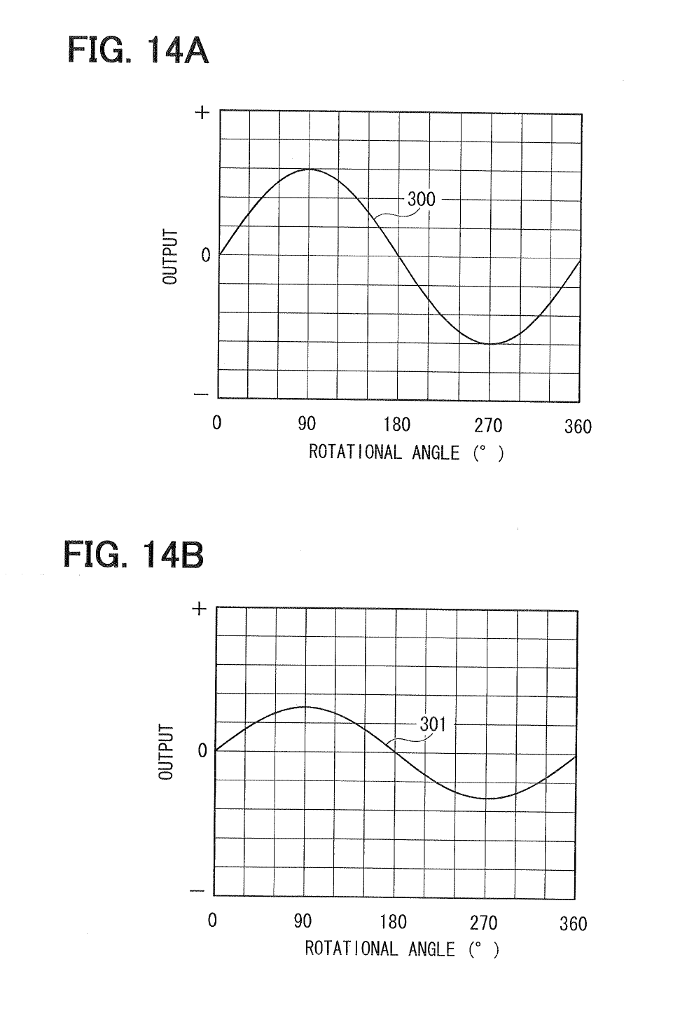

The magnetosensitive surface of the first Hall element 41 and the magnetosensitive surface of the second Hall element 42 are located on the central axis O. For example, when the permanent magnet 12 rotates 360 degrees about the Hall IC 40, the first Hall element 41 outputs signals as indicated by a signal curve 300 in FIG. 14A. Also, when the permanent magnet 12 rotates 360 degrees about the Hall IC 40, the second Hall element 42 outputs signals as indicated by a signal curve 301 in FIG. 14B. The signal curves 300, 301 each accords with a sinusoidal wave having a cycle of 360 degrees. Thus, it can be said that each of the signal curves 300, 301 is the exact sinusoidal wave. Therefore, the signal curve 300 and the signal curve 301 are, for example, expressed as A×sin(kθ) and B×sin(kθ), respectively, in which k is one (k=1).

Hereafter, a prior setup of the Hall IC 40 will be described. In the present embodiment, “output value acquisition”, “waveform estimation” and “amplitude adjustment” are performed as tasks of the prior setup.

<Output Value Acquisition>

In the stage of output value acquisition, the ECU 15 acquires values outputted from the first Hall element 41 and the second Hall element 42 at every angle of rotation of the rotating object. In this case, the ECU 15 receives the values outputted from the first Hall element 41 and the second Hall element 42 via the A/D converter 25, the DSP 26 and the D/A converter 28. The A/D converter 25, the DAP 26, the D/A converter 28 and the ECU 15 serves as an output value acquiring section. Hereinafter, the value outputted from the first Hall element 41 is also referred to as the first output value, and the value outputted from the second Hall element 42 is also referred to as the second output value.

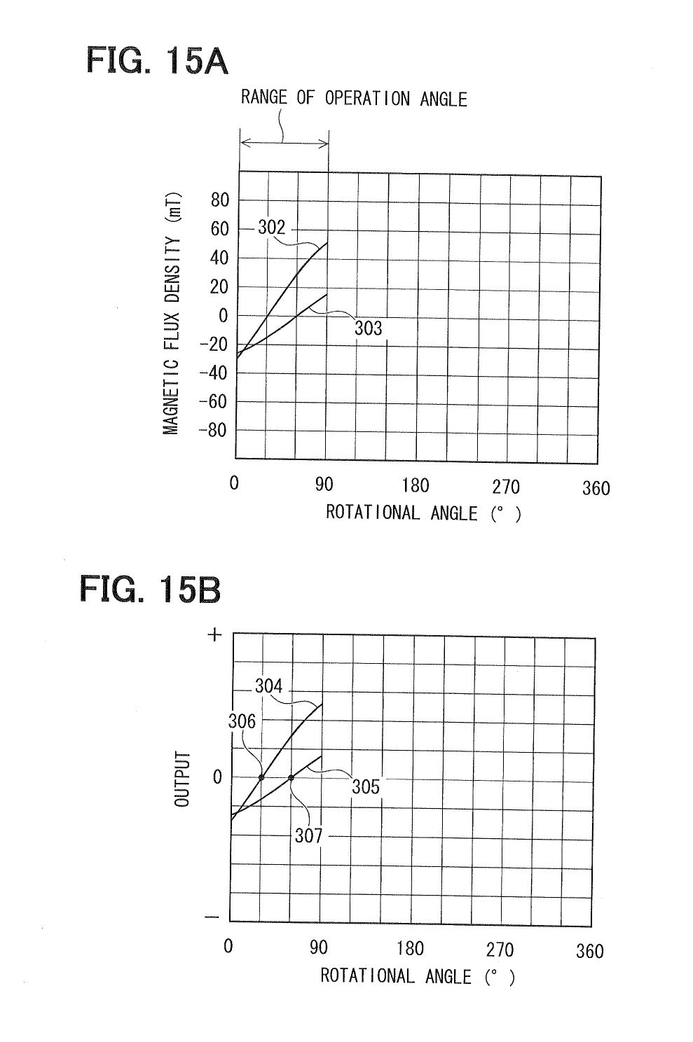

In the present embodiment, the rotating object is the valve shaft of the electronic throttle. A range of operation angle of the valve shaft is, for example from 0 to 90 degrees. Therefore, a magnetic flux density adjacent to the magnetosensitive surface of the first Hall element 41 is created as shown by a curve 302 of FIG. 15A. Also, a magnetic flux density adjacent to the magnetosensitive surface of the second Hall element 42 is created as shown by a curve 303 in FIG. 15A. Thus, the first output values and the second output values are expressed by points on a curve 304 and a curve 305 of FIG. 15B, respectively.

In the stage of the output value acquisition, the ECU 15 acquires the first output value and the second output value of every rotational angle of the rotating object, in such a manner that “the first output value is −29 and the second output value is −26, when the rotational angle of the rotating object is 0 degree”, “the first output value is −28 and the second output value is −25, when the rotational angle of the rotating object is 1 degree” . . . .

Since the range of the operation angle of the rotating object is from 0 to 90 degrees, the first output values and the second output values are obtained respectively in a range from 0 to 90 degrees, as shown in FIG. 15B. If the range of the rotational angle of the rotating object is sufficiently large, the sinusoidal wave over one cycle is formed by each of the first output values and the second output values. In the present embodiment, however, the waveform of each of the first output values and the second output values is formed for a 1/4 cycle. In this stage, therefore, the maximum value, that is, the amplitude of the waveform indicated by each of the first output values and the second output values is indistinct.

In the present embodiment, the permanent magnet 12 and the Hall IC 40 are arranged beforehand in a such a manner that rotational angles where the first output value and the second output value are zero are included. Therefore, value “0” is included in each of the first output values and the second output values, as shown by points 306, 307 of FIG. 15B.

<Waveform Estimation>

As described above, in the stage of the output value acquisition, the amplitude of the waveform of the first output values is indistinct, Similarly, the amplitude of the waveform of the second output values is indistinct. Therefore, in the stage of waveform estimation, the ECU 15 estimates one cycle of each waveform to calculate the amplitude of each waveform. Hereinafter, the waveform for one cycle of the signals outputted from the first Hall element 41 is referred to as a first estimation waveform. The waveform for one cycle of the signals outputted from the second Hall element 42 is referred to as a second estimation waveform. The ECU 15 serves as a waveform estimating section, that is, an estimation waveform generating section.

First, a method of estimating the first estimation waveform, that is, a method of generating the first estimation waveform will be described.

A phase of the first estimation waveform is calculated from the point 306 where the first output value is zero, as shown in 16A. In the present embodiment, an angle at the point 306 is β, and thus the phase of the first estimation waveform is defined as β. Assuming that the amplitude of the first estimation waveform is A, the first estimation waveform is expressed as A×sin(k(θ−β)). Here, k is a coefficient for correcting the cycle of the waveform of the signals outputted from the first Hall element 41 in a case where the signals outputted from the first Hall element 41 do not form the exact sinusoidal wave.

In the present embodiment, the coefficient k is one (k=1) since the first Hall element 41 is disposed on the central axis O and the signals outputted from the first Hall element 41 form the exact sinusoidal wave having the cycle of 360 degrees as shown by the signal curve 300 of FIG. 14A. In the following expressions, k is indicated for the sake of convenience.

The amplitude A of the first estimation waveform is calculated by a least squares method. Assuming that the output of the first Hall element 41 is Va(θi), and the waveform of the first estimation waveform is A×sin(kθi), the following expression (13) is obtained based on the above expressions (1) through (4):

A=Σ(Va(θi)sin(kθi))/(sin²(kθi)) (13)

In the present embodiment, since the coefficient k is one (k=1), the expression (13) is modified as follows:

A=Σ(Va(θi)sin θi)/Σ(sin² θi) (14)

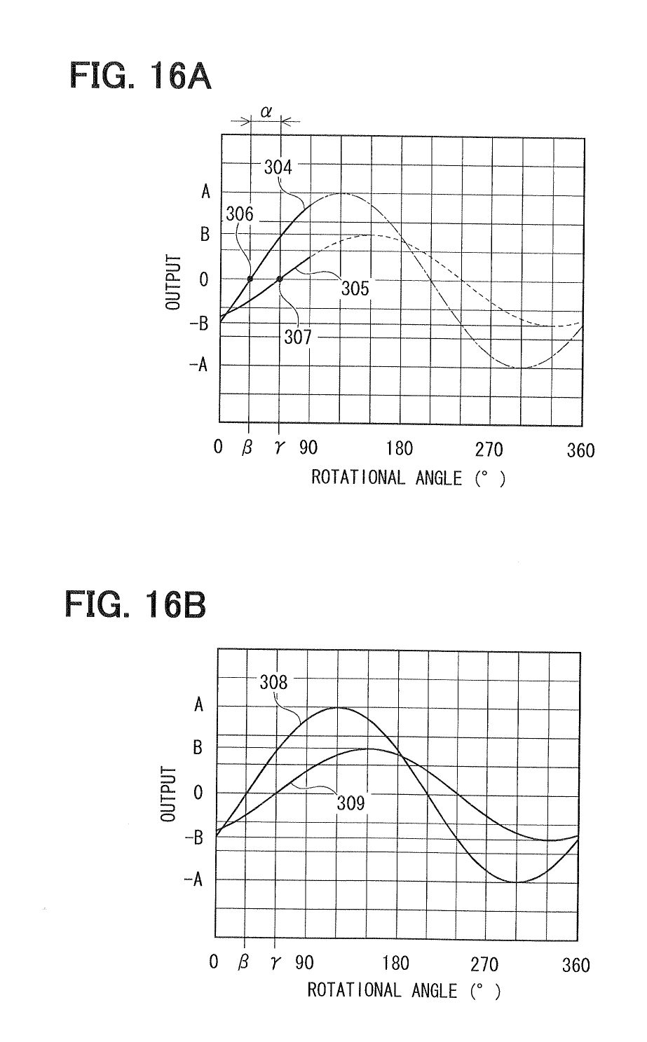

Accordingly, the first estimation waveform is obtained as shown by a curve 308 of FIG. 16B.

Next, a method of estimating the second estimation waveform, that is, a method of generating the second estimation waveform will be described.

A phase of the second estimation waveform is calculated from the point 307 where the second output value is zero as shown in 16A. In the present embodiment, an angle at the point 307 is γ, and thus the phase of the estimation waveform is γ. Assuming that the amplitude of the second estimation waveform is B, the second estimation waveform is expressed as B×sin(k(θ−γ)). Here, k is a coefficient for correcting the cycle of the waveform of the signals outputted from the second Hall element 42 in a case where the second output signals from the second Hall element 42 do not form the exact sinusoidal wave. In the present embodiment, the coefficient k is one (k=1) since the second Hall element 42 is disposed on the central axis O and the signals outputted from the second Hall element 42 form the exact sinusoidal wave having the cycle of 360 degrees as shown by the signal curve 301 of FIG. 14B. In the following expressions, k is indicated for the sake of convenience.

The amplitude B of the second estimation waveform is calculated by the least squares method, similar to the first estimation waveform. Assuming that the output of the second Hall element 42 is Vb(θi), and the waveform of the second estimation waveform is B×sin(kθi), the amplitude B is expressed as follows:

B=Σ(Vb(θi)sin(kθi))/Σ(sin²(kθi)) (15)

In the present embodiment, since the coefficient k is one (k=1), the expression (15) is modified as follows:

B=Σ(Vb(θi)sin θi)/Σ(sin² θi) (16)

Accordingly, the second estimation waveform is obtained as shown by a curve 309 of FIG. 16B.

At this point, as shown in FIG. 16B, the amplitude A of the first estimation waveform shown by the curve 308 and the amplitude B of the second estimation waveform shown by the curve 309 are different values.

<Amplitude Adjustment>

As described above, in the stage of the waveform estimation, the amplitude A of the first estimation waveform and the amplitude B of the second estimation waveform are different. Therefore, in the stage of amplitude adjustment, the ECU 15 adjusts the amplitude A of the first estimation waveform and the amplitude B of the second estimation waveform to be equal to each other. The ECU 15 serves as an amplitude adjusting section.

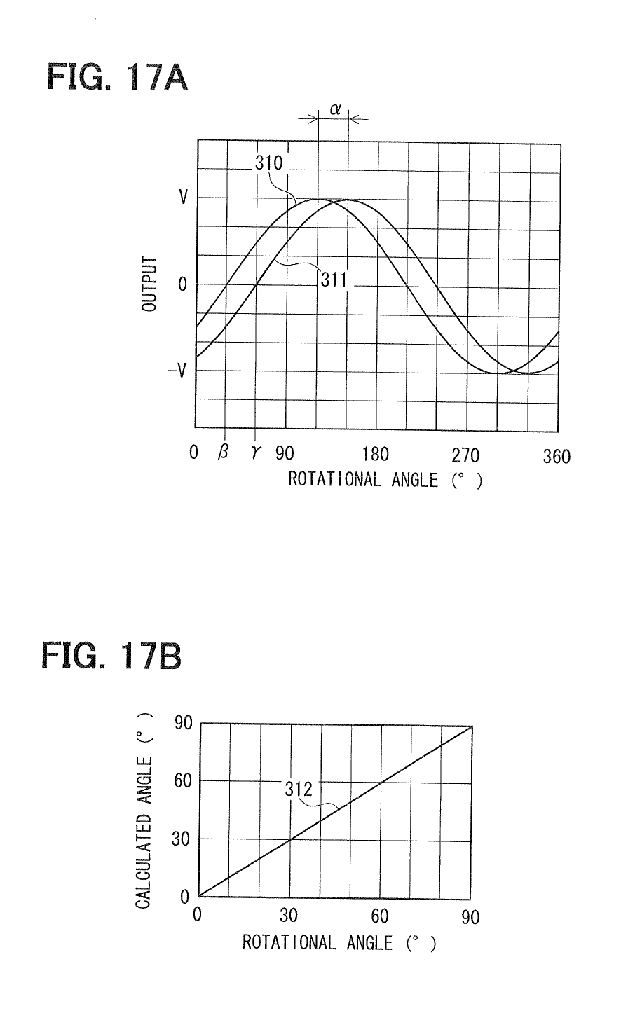

For example, each of the first estimation waveform and the second estimation waveform is fixed-multiplied to adjust the amplitude of each of the first estimation waveform and the second estimation waveform to V. Therefore, the first estimation waveform V×sin(θ−β) after the amplitude adjustment and the second estimation waveform V×sin(θ−γ) after the amplitude adjustment are shown by a curve 310 and a curve 311 in FIG. 17A, respectively. The memory 27 of the Hall IC 40 stores the value V as the amplitude of the first and second estimation waveforms after the amplitude adjustment.

In this way, the prior setup of the Hall IC 40 is performed.

Next, a method of detecting a rotational angle of the rotating object by the rotational angle detecting device 3 will be described. In the present embodiment, the following “rotational angle calculation” is performed to detect the rotational angle of the rotating object.

<Rotational Angle Calculation>

In the stage of rotational angle calculation, the DSP 26 calculates the rotational angle of the rotating object by a trigonometric function operation based on the first output value of the first Hall element 41, the second output value of the second Hall element 42, and the adjusted amplitude V of the first and second estimation waveforms, which is stored in the memory 27. Here, the DSP 26 serves as the rotational angle calculating section.

Assuming that the first output value of the first Hall element 41 is Va, the second output value of the second Hall element 42 is Vb, a phase difference between the waveform indicated by the first output values and the waveform indicated by the second output values is α=γ−β, an atmospheric temperature of the first and second Hall elements 41, 42 is t, a coefficient of temperature characteristic is K(t), a coefficient of temperature characteristic with regard to an electric current is I(t), a coefficient of temperature characteristic with regard to the magnetic flux density of the first Hall element 41 is Ba(t), a coefficient of temperature characteristic with regard to the magnetic flux density of the second Hall element 42 is Bb(t), and the rotational angle of the rotating object is θ,

Va=K(t)×I(t)×Ba(t)×sin(θ−β) (17)

Vb=K(t)×I(t)×Bb(t)×sin(θ−γ) (18)

In the present embodiment, in the stage of the waveform estimation, the first estimation waveform is estimated as A×sin(θ−β), and the second estimation waveform is estimated as B×sin(θ−γ). Further, in the stage of the amplitude adjustment, the amplitudes of the first and second estimation waveforms are adjusted to V. Based on this, the first output value Va and the second output value Vb are adjusted in amplitudes as follows:

Va′=Va×V/A

Vb′=Vb×V/B

Further, the rotational angle θ is calculated from the following expression (19):

θ=180°/Π×tan⁻¹(cot(α/2×Π/180°×(Va′−Vb′)/(Va′+Vb′) (19)

The DSP 26 obtains the first output value Va and the second output value Vb from the first Hall element 41 and the second Hall element 42, and calculates the rotational angle θ of the rotating object, as shown by a line 312 in FIG. 17B, by the trigonometric function operation using the expression (19) from the first output value Va and the second output value Vb.

In a case where α=90°, the rotational angle θ can be obtained by a following simple expression (20):

θ=180°/Π×tan⁻¹(Va′/Vb′) (20)

In the present embodiment, as shown in the expressions (19) and (20), the influence of temperature characteristics is canceled in the calculation of the rotational angle θ.

As described above, the rotational angle θ of the rotating object is calculated by the trigonometric function operation after estimating the first estimation waveform and the second estimation waveform, and adjusting the amplitudes of the first and second estimation waveforms to the amplitude V. In the present embodiment, the estimation of the first and second estimation waveforms by the waveform estimating section and the adjustment of the amplitudes by the amplitude adjusting section are performed beforehand. Therefore, unevenness of detection results in each product of the rotational angle detecting device 3 can be reduced. Therefore, the error of the detection results reduces, and detection accuracy improves.

The permanent magnet 12 and the Hall IC 40 have the positional relationship so that the rotational angles where the first output value of the first Hall element 41 and the second output value of the second Hall element 42 are zero are included. Therefore, the values approximate to zero in the signals outputted from the first Hall element 41 and the second Hall element 42 can be used to estimate the first estimation waveform and the second estimation waveform.

Further, because the S/N ratios of the first Hall element 41 and the second Hall element 42 improve and the phases of the first and second estimation waveforms are easily determined, the estimation of the waveform by the waveform estimating section can be accurately performed.

The first Hall element 41 and the second Hall element 42 are adjusted such that offsets thereof are zero. Therefore, since there is no offset even in a combination of the first and second Hall elements 41, 42 and the permanent magnet 12, the estimation of the waveform by the waveform estimating section can be further accurately performed.

The waveform estimating section calculates the phases of the first estimation waveform and the second estimation waveform respectively from the points where the first output value and the second output value are zero. Further, the waveform estimating section calculates the amplitudes of the first and second estimation waveforms respectively by the least squares method so as to estimate the first estimation waveform and the second estimation waveform. Accordingly, the first estimation waveform and the second estimation waveform are accurately estimated. As a result, the rotational angle θ of the rotating object can be accurately calculated by the rotational angle calculating section.

Further, the first Hall element 41, the second Hall element 42, the DSP 26 serving as the output value acquiring section and the rotational angle calculating section, and the like are mounted in the single semiconductor chip. Since the first Hall element 41 and the second Hall element 42 are mounted in the same semiconductor chip, the characteristics of the first Hall element 41 and the second Hall element 42 can be equalized. As such, the rotational angle can be accurately detected. Moreover, since the first Hall element 41, the second Hall element 42, the DSP 26, and the like are mounted in the single semiconductor chip, the overall size of the rotational angle detecting device 3 can be reduced.

### Fourth Embodiment

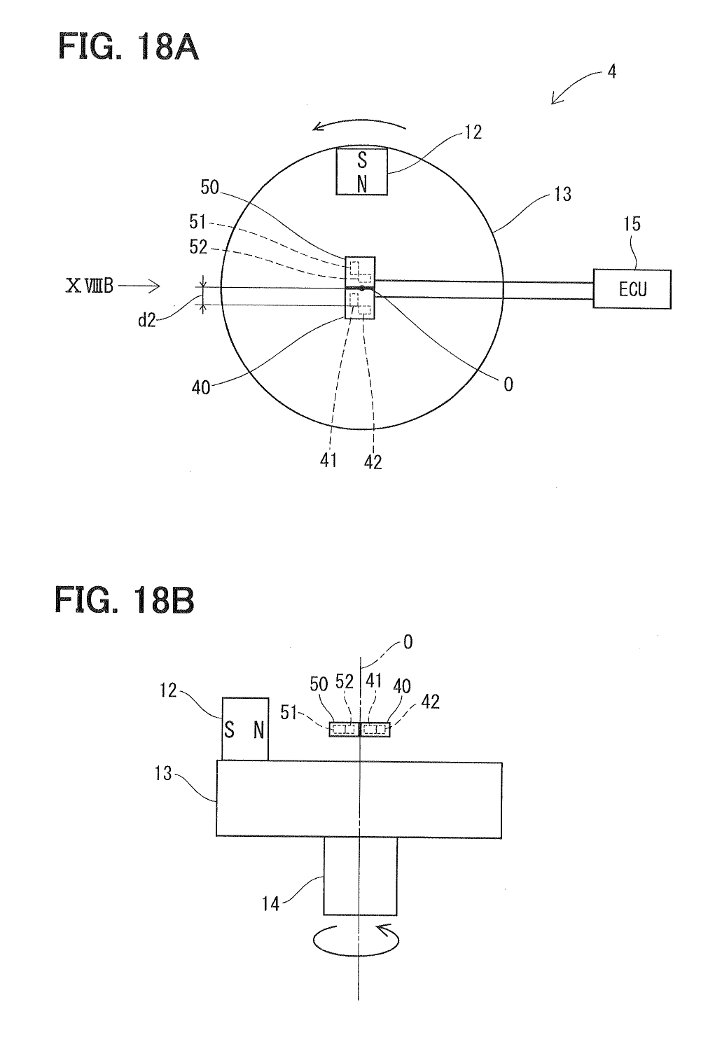

A fourth embodiment will be described with reference to FIGS. 18A and 18B. A rotational angle detecting device 4 according to the fourth embodiment is different from the rotational angle detecting device 3 because a Hall IC for backup detection is added and the Hall ICs are arranged differently.

Referring to FIGS. 18A and 18B, the rotational angle detecting device 4 has a Hall IC 50, in addition to the Hall IC 40.

The Hall IC 40 and the Hall IC 50 are disposed on opposite sides of the central axis O. The Hall IC 50 includes a first Hall element 51 and a second Hall element 52. The first Hall element 51 and the second Hall element 52 are disposed opposite to the first Hall element 41 and the second Hall element 42 with respect to the central axis O. In the present embodiment, the Hall IC 50 is employed as backup. That is, although the Hall IC 40 normally detects the magnetic field, if the Hall IC 40 cannot detect the magnetic field due to an abnormality or the like, the Hall IC 50 detects the magnetic field. In the present embodiment, the Hall IC 40 serves as the magnetic sensor. Further, the first Hall element 41 serves as the first sensor element, and the second Hall element 42 serves as the second sensor element. An internal structure of the Hall IC 50 is similar to the internal structure of the Hall IC 40.

The Hall IC 40 and the backup Hall IC 50 are disposed adjacent to the central axis O. Therefore, the magnetosensitive surface of the first Hall element 41 and the magnetosensitive surface of the second Hall element 42 are spaced from the central axis O by a predetermined distance d2, respectively. In such a construction, for example, when the permanent magnet 12 rotates 360 degrees around the Hall IC 40, the signals outputted from the first Hall element 41 and the signals outputted from the second Hall element 42 do not form the exact sinusoidal waves.

In the present embodiment, therefore, the cycles of the signals outputted from the first Hall element 41 and the second Hall element 42 are corrected using the coefficient k (k≠1), similar to the method of the second embodiment. After correcting the cycles, the waveform estimation, the amplitude adjustment and the rotational angle calculation are performed in the similar manner as those of the third embodiment.

Namely, in the present embodiment, in the stage of the rotational angle calculation, the rotational angle θ of the rotating object is calculated by the following expression (21):

θ=(180°/Π×tan^{-l}(cot(α/2×Π/180°)×(Va′−Vb′)/(Va′+Vb′)))/k (21)

In the case where the phase difference between the signal from the first Hall element 41 and the signal from the second Hall element 42 (γ−β=α) is 90 degrees, the rotational angle θ is calculated by the following expression (22):

θ=(180°/Π×tan⁻¹(Va′/Vb′))/k (22)

### Other Embodiments

The shape and arrangement of the magnetic member such as the permanent magnet 12 can be modified in various other ways as long as signals indicating an approximately sinusoidal wave is obtained from the magnetic sensor such as the Hall IC.

In the above-described embodiments, the permanent magnet and the Hall IC are arranged to have the positional relationship so that the rotational angle where the output value of the sensor element is zero is included. Alternatively, the permanent magnet and the Hall IC can be arranged such that the rotational angle where the output value of the Hall element is zero is not included.

Further, the ECU 15 can be mounted in the semiconductor chip of the Hall IC together with the Hall elements, the DSP 26 and other components. In such a case, all the processing including the prior setup can be executed in the Hall IC. The tasks described as the prior setup, such as the waveform estimation, the amplitude normalization and the amplitude adjustment, are not limited to be performed previously, but can be executed every time as detecting the rotational angle.

In the above-described embodiments, the rotational angle calculation is exemplarily performed by the DSP 26 in the Hall IC. Alternatively, the rotational angle calculation can be performed by the ECU 15.

In the above-described embodiments, the waveform estimation, the amplitude normalization and the amplitude adjustment of the prior setup are exemplarily performed by the ECU of a vehicle. Alternatively, the waveform estimation, the amplitude normalization and the amplitude adjustment can be performed previously by a computer or a processing unit, which is not mounted on a vehicle. In such a case, the computer or the processing unit constitutes a part of the rotational angle detecting device 1 to 4.

The rotational angle detecting device 1 to 4 can be employed to detect the rotational angle of any rotating objects, such as a rotation shaft of an acceleration pedal or a crank shaft, other than the electronic throttle.

Additional advantages and modifications will readily occur to those skilled in the art. The invention in its broader term is therefore not limited to the specific details, representative apparatus, and illustrative examples shown and described.

What is claimed is:

1. A rotational angle detecting device for detecting a rotational angle of a rotating object, comprising:
a magnetic member generating a magnetic field;
a magnetic sensor including a sensor element that is disposed to rotate relative to the magnetic member in accordance with a rotation of the rotating object, and outputs signals according to a change in the magnetic field caused as rotating relative to the magnetic member; and
a processing unit capable of processing output values of the sensor element, the processing unit including:
means for acquiring the output value at every angle of rotation of the rotating object;
means for generating an estimation waveform from the output values acquired by the means for acquiring the output value, the estimation waveform corresponding to a waveform for one cycle of the signals outputted from the sensor element;
means for normalizing an amplitude of the estimation waveform; and
means for calculating a rotational angle of the rotating object by a trigonometric function operation based on the output value and a normalized amplitude.

2. The rotational angle detecting device according to claim 1, wherein
the magnetic member and the magnetic sensor are arranged to have a positional relationship to each other so that a rotational angle at which the output value of the sensor element is zero is included.

3. The rotational angle detecting device according to claim 1, wherein
the sensor element is adjusted so that an offset thereof is zero.

4. The rotational angle detecting device according to claim 1, wherein
the means for generating the estimation waveform generates the estimation waveform by calculating a phase of the estimation waveform from a point where the output value is zero and calculating the amplitude of the estimation waveform by a least squares method.

5. The rotational angle detecting device according to claim 1, wherein
the means for generating the estimation waveform generates the estimation waveform after correcting a cycle of the signals outputted from the sensor element.

6. The rotational angle detecting device according to claim 1, wherein
the sensor element is mounted in a single semiconductor chip together with at least one of the means for acquiring the output value, the means for generating the estimation waveform, the means for normalizing the amplitude, and the means for calculating the rotational angle.

7. A rotational angle detecting device for detecting a rotational angle of a rotating object, comprising:
a magnetic member generating a magnetic field;
a magnetic sensor including a first sensor element and a second sensor element that are disposed to rotate relative to the magnetic member in accordance with a rotation of the rotating object, and respectively output first signals and second signals according to a change in the magnetic field caused as rotating relative to the magnetic member; and
a processing unit capable of processing first output values of the first sensor element and second output values of the second sensor element, the processing unit including:
means for acquiring the first output value and the second output value at every angle of rotation of the rotating object;
means for generating a first estimation waveform and a second estimation waveform from the first output values and the second output values acquired by the means for acquiring the first output value and the second output value, the first estimation waveform corresponding to a waveform for one cycle of the first signals, and the second estimation waveform corresponding to a waveform for one cycle of the second signals;
means for adjusting an amplitude of the first estimation waveform and an amplitude of the second estimation waveform to be equal; and
means for calculating a rotational angle of the rotating object by a trigonometric function operation based on the first output value, the second output value, and an adjusted amplitude of the first estimation waveform and the second estimation waveform.

8. The rotational angle detecting device according to claim 7, wherein
the magnetic member and the magnetic sensor are arranged to have a positional relationship to each other so that rotational angles at which the first output value and the second output value are zero are included.

9. The rotational angle detecting device according to claim 7, wherein
the first sensor element and the second sensor element are respectively adjusted so that offsets thereof are zero.

10. The rotational angle detecting device according to claim 7, wherein
the means for generating the first estimation waveform and the second estimation waveform generates the first estimation waveform and the second estimation waveform by calculating phases of the first estimation waveform and the second estimation waveform from points where the first output value and the second output value are zero, and calculating the amplitudes of the first estimation waveform and the second estimation waveform by a least square method.

11. The rotational angle detecting device according to claim 7, wherein
the means for generating the first estimation waveform and the second estimation waveform generates the first estimation waveform and the second estimation waveform after correcting cycles of the first signals and the second signals.

12. The rotational angle detecting device according to claim 7, wherein
the first sensor element and the second sensor element are mounted in a single semiconductor chip together with at least one of the means for acquiring the first output value and the second output value, the means for generating the first estimation waveform and the second estimation waveform, the means for adjusting the amplitudes, and the means for calculating the rotational angle.
